(19) United States
(12) Patent Application Publication
(10) Pub. No.: US 2005/0275189 A1
(43) Pub. Date: Dec. 15, 2005

(54) Two wheel drive bicycle with wheelie action

(76) Inventors: Pietrina Giordanella, Lindenhurst, NY (US); John Bohata, Lindenhurst, NY (US)

Correspondence Address: Galgano & Burke, Suite 35, 300 Rabro Drive, Hauppauge, NY, 11788, US

(21) Appl. No.: 10/864,993

(22) Filed: Jun. 10, 2004

(51) Int. Cl. B62M 1/00; B62K 5/00

(52) U.S. Cl. 280/239; 280/261

(57) ABSTRACT

A two wheel drive bicycle with wheelie action includes two spaced apart drive wheels coupled to an A-frame which is pivotally coupled to the main bicycle frame. The A-frame is provided with a wheelie stop which prevents the bicycle from tipping too far backward during a wheelie stunt. A transfer drive assembly couples drive sprockets of both drive wheels to a pedal driven crank sprocket on the main bicycle frame via two chains.

### BACKGROUND OF THE INVENTION

1. Field of the Invention

This invention relates broadly to bicycles. More particularly, this invention relates to a bicycle having a two wheel drive and a limited pivot to facilitate performance of wheelies.

2. State of the Art

The “wheelie” has long been a favorite stunt among riders of two wheeled vehicles, i.e. bicycles and motorcycles. A wheelie is performed by lifting the front wheel of the bicycle or motorcycle off the ground while continuing to propel the cycle forward on one wheel (the rear wheel. Children, in particular, delight in performing wheelies with bicycles. However, the performance of a wheelie (also known as “popping a wheelie”) is somewhat difficult and dangerous.

There have been several proposals in the art to modify a bicycle in a certain way to facilitate the performance of a wheelie and/or to lessen the danger involved when performing a wheelie. U.S. Pat. No. 3,321,047, issued May 23, 1967 to Ryan et al., discloses a “vehicle control apparatus”. The apparatus includes a safety brake attached to a bicycle in such a manner that the safety brake applies braking action to the rear wheels of the bicycle when the vehicle frame tilts towards the rear past a point at which a rider is safely balanced to minimize the possibility of the rider falling over backwards. In one embodiment, the safety brake is attached to the bicycle frame and includes a friction surface which is positioned rearward of the ground-engaging portion of the tire on the rear wheel of the bicycle when it is in normal riding position and which becomes adjacent the ground-engaging portion when the bicycle is tilted backwards beyond a predetermined amount, whereby the progressive bulging of the bicycle tire due to the added weight on the ground-engaging portion causes the tire to engage the friction surface producing a braking action on the rear wheel. When the bicycle and rider are proceeding along on the rear wheel only, this braking action tends to pivot the rider and the upper portion of the bicycle forward so that the rider will not fall over backwards when the bicycle is tilted beyond said predetermined amount. In another embodiment, the safety brake includes a gravity sensor, such as a pendulum, which actuates a brake on the rear wheel of the bicycle when the plane between the front and rear wheels of the bicycle departs a predetermined amount from the plane of the surface on which the bicycle is moving. In still another embodiment, the safety brake comprises a ground sensor in the form of a feeler wheel which reports the extent to which the plane between the bottom of the front and rear wheels has de-parted from the plane of the surface on which the bike is riding and which actuates a brake mechanism to prevent further rotation of the rear wheel when this departure exceeds a predetermined amount.

U.S. Pat. No. 4,012,054, issued Mar. 15, 1977 to Moore, discloses a “bicycle safety device” for stabilizing a bicycle when the front wheel of the bicycle is elevated above the ground. The apparatus includes rollers or wheels that are mounted on the ends of rigid arms that extend outwardly and rearwardly from the back wheel of the bicycle. The rollers or wheels are maintained in spaced apart relationship with the axis of the rollers or wheels being in approximately the same horizontal plane as the rear axle of the bicycle when both wheels of the bicycle are in contact with the ground. The rollers or wheels of the safety apparatus are substantially smaller than the wheels of the bicycle such that when the front end of the bicycle is elevated, a three point contact is made by the rear wheel of the bicycle and the spaced apart rollers or wheels to stabilize the bicycle and prevent it from tipping over backwards.

U.S. Pat. No. 4,154,452, issued May 15, 1979 to Newman, discloses a “bicycle safety accessory” for preventing tipping over when the rider is executing a wheelie maneuver. The safety accessory includes a third wheel which is positioned directly behind the rear wheel of the bicycle and normally out of contact with the ground. The auxiliary wheel is carried by a pair of rearwardly extending support arms which are attached to the rear wheel and framework of the bicycle by special purpose brackets such that the normal position of the auxiliary wheel is substantially vertically adjustable.

U.S. Pat. No. 4,353,571, issued Oct. 12, 1982 to Anderson, discloses a “wheelie support” for a bicycle or a motorcycle. One embodiment shows a third wheel similar to the apparatus described above. Another embodiment shows a skid plate attached to the rear fender.

U.S. Pat. No. 5,330,221, issued Jul. 19, 1994 to Sutton, discloses a “bicycle wheelie balancing device” which serves as a learning aid in practicing wheelie stunts. The device is similar to those described above, having a pair of support rollers mounted on a frame which extends rearward from the rear wheel of the bicycle.

More recently, U.S. Pat. No. 6,149,179, issued Nov. 21, 2000 to Long, discloses a “wheelie stabilizer and safety device” that includes a mounting bracket, a pivotable arm assembly, a hinge, a stabilizer wheel assembly, and a spring. The mounting bracket is attached to a rear axle of a bicycle, with the pivotable arm assembly extending rearwardly therefrom and terminating in the hinge. The stabilizer wheel assembly is, in turn, hingably coupled to the hinge. The spring is disposed between the mounting bracket and the pivotable arm to provide flexion of the arm when, in operation, ground contact is made with the stabilizer wheel assembly.

Generally speaking, the known apparatus for assisting in the performance of wheelies include either roller/wheel assemblies which contact the ground only when a wheelie is being performed and/or friction devices.

### SUMMARY OF THE INVENTION

It is therefore an object of the invention to provide a new kind of bicycle which is specifically designed for performing wheelies.

It is another object of the invention to provide a bicycle which makes it easier for a child to perform wheelies.

It is a further object of the invention to provide a bicycle which makes performing wheelies safer.

In accord with these objects, which will be discussed in detail below, the bicycle of the present invention includes a front wheel coupled to a fork and handlebars which are mounted in a main bicycle frame which carries a seat post, a seat, and a pedal driven crank sprocket. According to the invention, two rear drive wheels are provided in substantially the same plane with their drive axes being spaced fore and aft. The two rear drive wheels are mounted in a tandem A-frame which is pivotally coupled to a tandem support tube which is coupled to the main bicycle frame. The A-frame is coupled to the tandem support tube by a tandem pivot tube which includes a transfer drive assembly. The transfer drive assembly includes two transfer drive sprockets which are fixed to each other but rotatable relative to the tandem pivot tube. Each of the two drive wheels is coupled to a drive sprocket and the two drive sprockets are coupled by a drive chain to one of the two transfer drive sprockets. The other transfer drive sprocket is coupled to the crank sprocket by a crank chain. The A-frame is provided with at least one cross member which functions as a wheelie stop. In particular, when performing a wheelie, as the front wheel is raised from the ground, the tandem support tube is rotated with the tandem pivot tube relative to the A-frame. When the front wheel is raised a predetermined amount, the tandem support tube reaches the wheelie stop which prevents further rotation.

Certain of the foregoing and related objects are also attained in a two wheel drive bicycle embodying the present invention, comprising a bicycle frame, a front wheel coupled to said bicycle frame, a pair of rear drive wheels coupled to said bicycle frame, said drive wheels lying in substantially the same plane with their respective axes being spaced apart fore and aft, and a pedal driven drive sprocket mounted on said bicycle frame and coupled to both of said drive wheels such that rotation of said drive sprocket causes rotation of both of said drive wheels.

Preferably, the bicycle further infludes an A-frame pivotally coupled to said bicycle frame, said drive wheels being rotatably coupled to said A-frame. Desirably, the bicycle further comprises a transfer drive assembly coupled to said A-frame, wherein each of said drive wheels has a drive sprocket, said drive sprockets being coupled to said transfer drive assembly by a first chain and said pedal driven drive sprocket being coupled to said transfer drive assembly by a second chain. Advantageously, said transfer drive assembly includes an outer pivot tube fixedly coupled to said bicycle frame and an inner cross tube rotatably coupled to said A-frame.

Most desirably, the transfer drive assembly includes a pair of transfer drive sprockets non-rotatably coupled to each other and rotatably coupled to said inner cross tube, with one of said transfer drive sprockets being coupled to said first chain and the other of said transfer drive sprockets being coupled to said second chain. Most advantageously, the transfer drive assembly includes a bushing disposed between said outer pivot tube and said inner cross tube. The transfer drive assembly preferably includes a sprocket bearing disposed between said pair of transfer drive sprockets and said inner cross tube. The transfer drive assembly also preferably includes a sprocket bearing retainer cup disposed between said pair of transfer drive sprockets and said sprocket bearing. In a preferred embodiment, the bushing is two nylon bushings and said sprocket bearing is two sprocket bearings.

Certain of the foregoing and related objects are also attained according to the present invention by the provision of, a two wheel drive bicycle, comprising a bicycle frame, a front wheel coupled to said bicycle frame, an A-frame pivotally coupled to said bicycle frame, and a pair of rear drive wheels rotatably coupled to said A-frame, said drive wheels lying in substantially the same plane with their respective axes being spaced apart fore and aft.

Preferably, said A-frame includes a cross member which limits rearward pivotal movement of said bicycle frame relative to said A-frame. Advantageously, the bicycle further comprises a transfer drive assembly coupled to said A-frame, wherein at least one of said drive wheels has a drive sprocket, and said drive sprocket is coupled to said transfer drive assembly by a first chain. Describing, the transfer drive assembly includes an outer pivot tube fixedly coupled to said bicycle frame and an inner cross tube rotatably coupled to said A-frame.

In a particularly advantageous embodiment, the transfer drive assembly includes a pair of transfer drive sprockets non-rotatably coupled to each other and rotatably coupled to said inner cross tube, and one of said transfer drive sprockets being coupled to said first chain. The transfer drive assembly preferably includes a bushing disposed between said outer pivot tube and said inner cross tube and a sprocket bearing disposed between said pair of transfer drive sprockets and said inner cross tube.

The transfer drive assembly preferably includes a sprocket bearing retainer cup disposed between said pair of transfer drive sprockets and said sprocket bearing and said bushing is two bushings and said sprocket bearing is two sprocket bearings.

Additional objects and advantages of the invention will become apparent to those skilled in the art upon reference to the detailed description taken in conjunction with the provided figures.

### BRIEF DESCRIPTION OF THE DRAWINGS

FIG. 1 is a side elevation view showing a bicycle embodying the present invention in the position of performing a wheelie;

FIG. 2 is an enlarged perspective view of the drive wheels, A-frame, and transfer drive assembly;

FIG. 3 is an enlarged perspective view of the circled portion of FIG. 2;

FIG. 4 is a side elevation view showing the bicycle in the normal riding position;

FIG. 5 is an enlarged view of the circled portion of FIG. 4;

FIG. 6 is a perspective view of the bicycle in the normal riding position;

FIG. 7 is an enlarged perspective view of the circled portion of FIG. 6;

FIG. 8 is a side elevation view of the transfer drive assembly including the transfer pivot tube;

FIG. 9 is a cross section taken along line 9-9 in FIG. 8;

FIG. 10 is an end view of the transfer drive assembly; and

FIG. 11 is a perspective view of the transfer drive assembly.

### DETAILED DESCRIPTION OF THE PREFERRED EMBODIMENTS

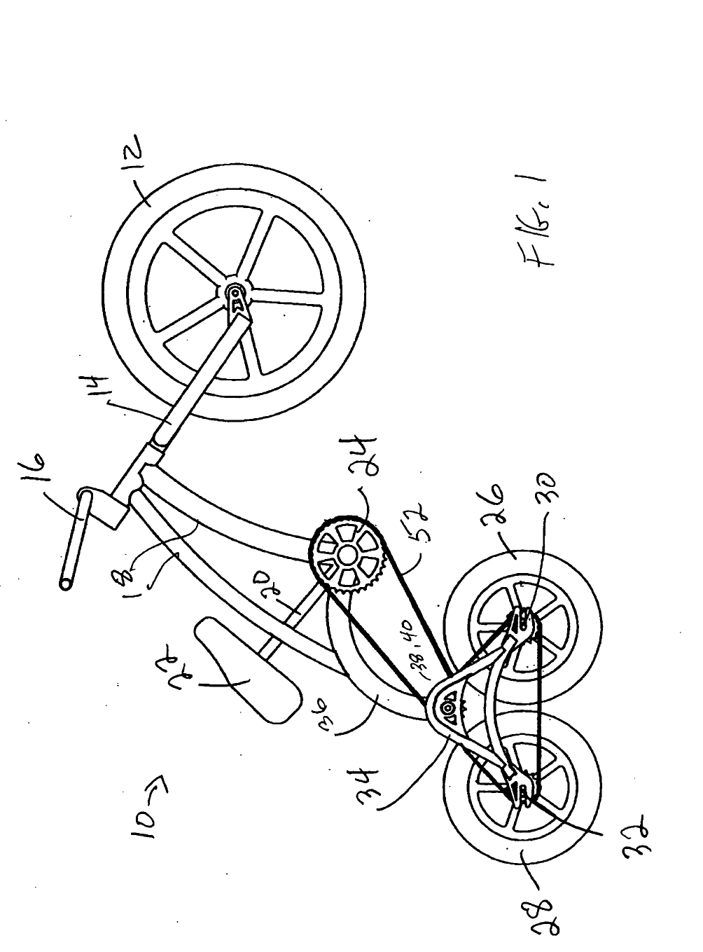

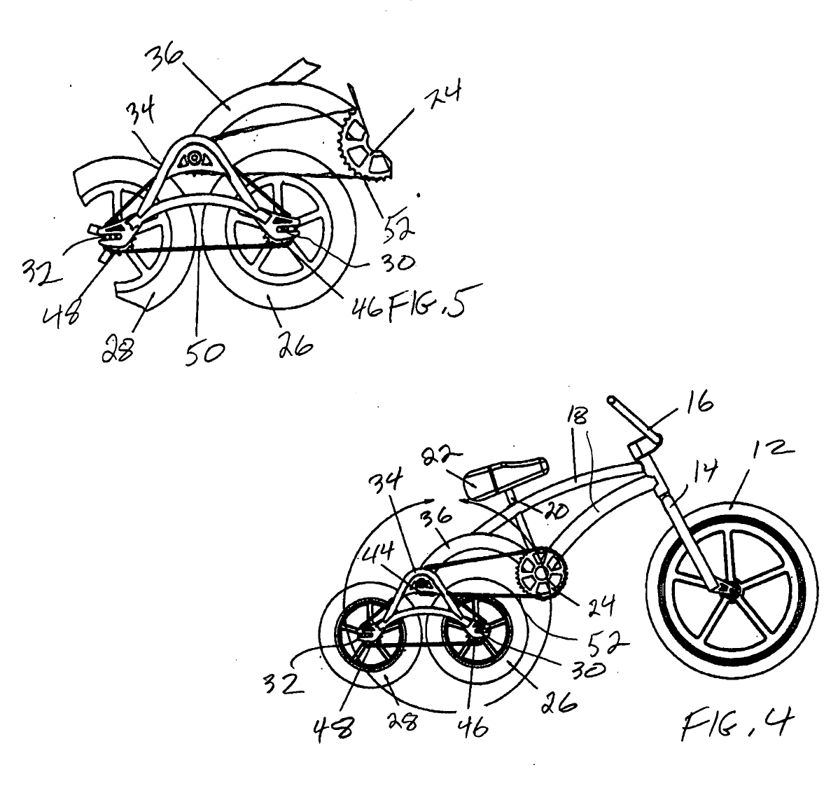

Turning now to FIG. 1, the bicycle 10 of the present invention includes a front wheel 12 coupled to a fork 14 and handlebars 16 which are mounted in a main bicycle frame 18 which carries a seat post 20, a seat 22, and a pedal driven crank sprocket 24. According to the invention, two rear drive wheels 26, 28 are provided in substantially the same plane with their drive axles 30, 32 being spaced fore and aft. The two rear drive wheels are mounted in a tandem A-frame 34 which is pivotally coupled to a tandem support tube 36 which is coupled to the main bicycle frame 18. The A-frame 34 is coupled to the tandem support tube 36 by a tandem pivot tube 38 which includes a transfer drive assembly 40 which is shown and described in more detail below. As seen best in FIGS. 4 and 5, the support tube 36 has a radius of curvature which is substantially concentric with the drive axle 30 of the wheel 26.

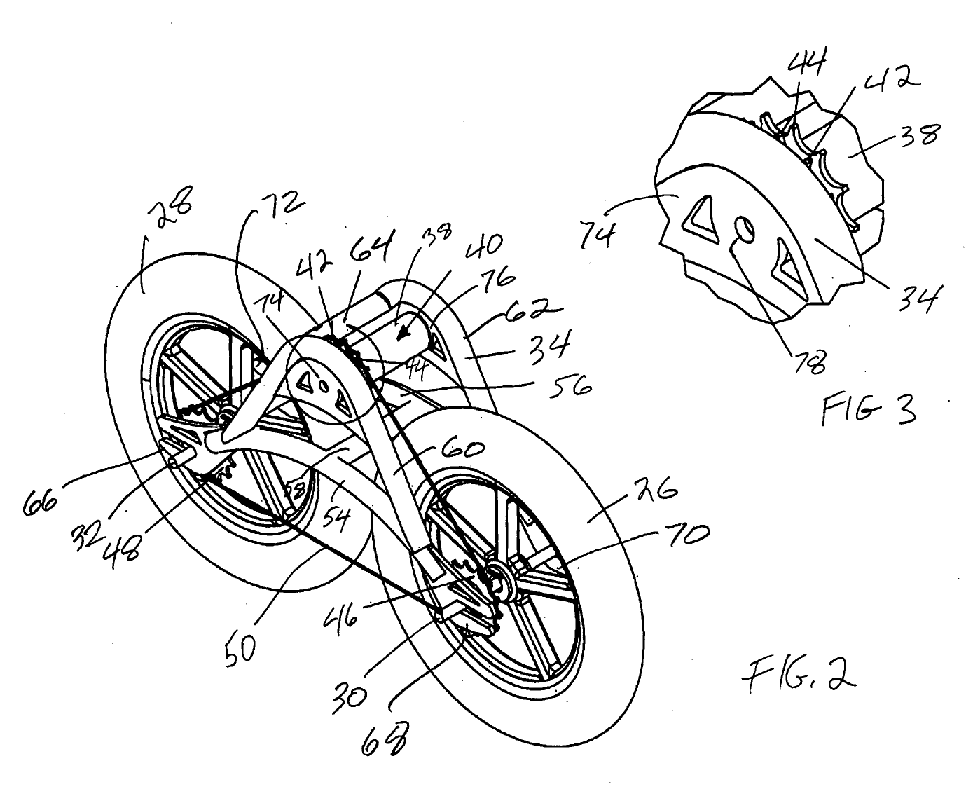

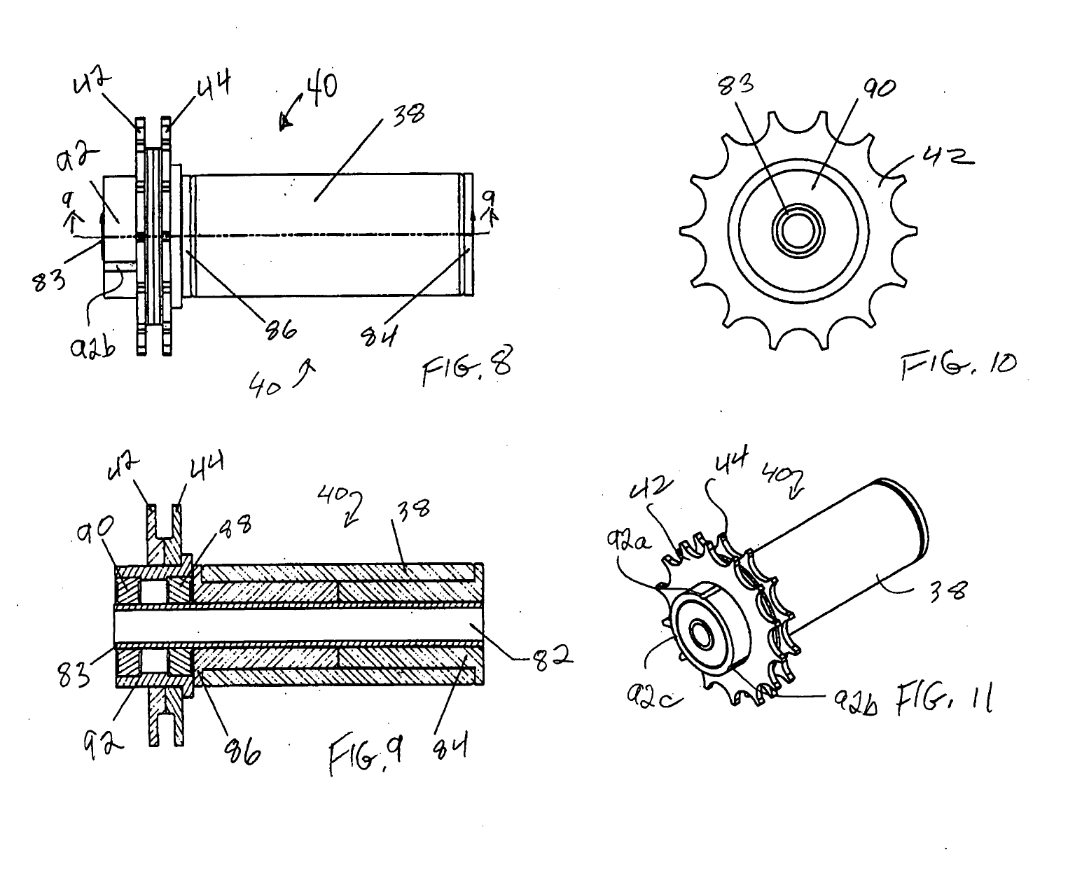

As seen in FIGS. 2 and 3 (as well as FIGS. 8-11) the transfer drive assembly includes two transfer drive sprockets 42, 44 which are fixed to each other but rotatable relative to the tandem pivot tube 38. Each of the two drive wheels 26, 28 is respectively coupled to a drive sprocket 46, 48, and the two drive sprockets are coupled by a drive chain 50 to one transfer drive sprocket 42. As seen in FIGS. 1, 4, 5, and 6, the other transfer drive sprocket 44 is coupled to the crank sprocket 24 by a crank chain 52.

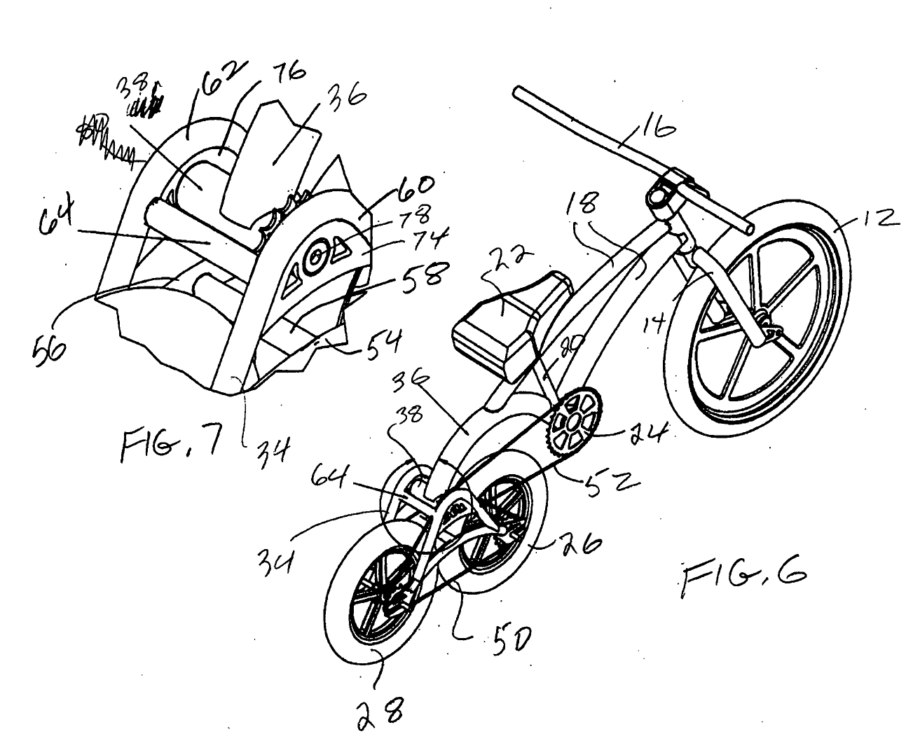

As seen best in FIGS. 2, 6, and 7, the A-frame 34 is comprised of two lower bowed tubes 54, 56 which are coupled to each other by a first cross member 58 and two upper inverted-V members 60, 62 which are coupled to each other by a second cross member 64. The lower extremities of the bowed tubes 52, 54 are provided with wheel mounts 66, 68, 70, 72 which couple to the axles 30, 32 of the wheels 26, 28. Mounting plates 74, 76 are provided at the apices of the inverted-V members 60, 62. The mounting plates 74, 76 are provided with mounting bores 78 for rotatably supporting the transfer drive assembly 40.

Referring now to FIGS. 8-11, the transfer drive assembly 40 includes an outer tandem pivot tube 38 and an inner tandem cross tube 82 which is mounted coaxially with the pivot tube 38 by a pair of generally cylindrical press-fit nylon bushings 84, 86. A portion 83 of the cross tube 82 extends beyond the pivot tube 38 and bushings 84, 86. It is on this portion that the transfer drive sprockets 42, 44 are mounted. In particular, a pair of sprocket bearings 88, 90 are mounted on the portion 83 of the tube 82 with a bearing retainer cup 92 so that the cup 92 is freely rotatable relative to the tube 82. As seen best in FIGS. 8 and 11, the bearing retainer cup 92 is splined, e.g., with grooves 92a-92c, which engage the sprockets 42, 44.

Referring once again to FIGS. 5 and 6, it can be seen that the pivot tube 38 is coupled, e.g. by welding, to the tandem support tube 36. The entire assembly 40 is coupled to the A-frame 34 by passing a stud or bolt (not shown) through the bore 78 and the tube 82 and affixing it with a nut (not shown) to mounting plates 74, 76. Thus, the pivot tube 38 and, in turn, the support tube 36 are free to rotate relative to the A-frame 34.

However, it will be appreciated that the cross member 64 functions as a wheelie stop to prevent the operator from falling backward off the bicycle when performing a “wheelie”. In particular, when performing a wheelie, as the front wheel 12 is raised from the ground, the tandem support tube 36 is rotated upwardly and rearwardly with the tandem pivot tube 38 relative to the A-frame 34. When the front wheel is raised a predetermined amount, the tandem support tube 36 reaches and abuts the wheelie stop 64 which prevents further rotation and prevents the bicycle from falling over backwards (FIG. 1). Although not shown, the stop 64 can be provided with a concave or channeled surface which guides and mates with the rearward curved surface of support tube 36.

Those skilled in the art will appreciate that the tandem rear wheels which are pivotally mounted to the bicycle frame remain on the ground at all times, thereby facilitating safer and more stable wheelies. They also serve to smooth the ride on rough or uneven terrain. As will also be appreciated, the bicycle can be provided with conventional brake and suspension assemblies which only need to be modified to accommodate the A-frame and two wheel drive assembly.

There has been described and illustrated herein a two wheel drive bicycle with wheelie action. While particular embodiments of the invention have been described, it is not intended that the invention be limited thereto, as it is intended that the invention be as broad in scope as the art will allow and that the specification be read likewise. It will therefore be appreciated by those skilled in the art that yet other modifications could be made to the provided invention without deviating from its spirit and scope as claimed.

1. A two wheel drive bicycle, comprising:
a bicycle frame;
a front wheel coupled to said bicycle frame;
a pair of rear drive wheels coupled to said bicycle frame, said drive wheels lying in substantially the same plane with said drive wheels being spaced apart fore and aft;
a pedal driven drive sprocket mounted oh said bicycle frame and coupled to both of said drive wheels such that rotation of said drive sprocket causes rotation of both of said drive wheels; and
a rear wheel frame pivotally coupled to said bicycle frame, said drive wheels being rotatable coupled to said rear wheel frame.

2. A two wheel drive bicycle according to claim 1, wherein said rear wheel frame includes a cross member which limits rearward pivotal movement of said bicycle frame relative to said rear wheel frame.

3. A two wheel drive bicycle according to claim 2, wherein said rear wheel frame comprises an A-frame and wherein said bicycle further comprises:
a transfer drive assembly coupled to said A-frame, wherein
each of said drive wheels has a drive sprocket, said drive sprockets being coupled to said transfer drive assembly by a first chain and said pedal driven drive sprocket being coupled to said transfer drive assembly by a second chain.

4. A two wheel drive bicycle according to claim 3, wherein:
said transfer drive assembly includes an outer pivot tube fixedly coupled to said bicycle frame and an inner cross tube rotatably coupled to said A-frame.

5. A two wheel drive bicycle according to claim 4, wherein:
said transfer drive assembly includes a pair of transfer drive sprockets non-rotatably coupled to each other and rotatably coupled to said inner cross tube,
one of said transfer drive sprockets being coupled to said first chain and the other of said transfer drive sprockets being coupled to said second chain.

6. A two wheel drive bicycle according to claim 5, wherein:
said transfer drive assembly includes a bushing disposed between said outer pivot tube and said inner cross tube.

7. A two wheel drive bicycle according to claim 6, wherein:
said transfer drive assembly includes a sprocket bearing disposed between said pair of transfer drive sprockets and said inner cross tube.

8. A two wheel drive bicycle according to claim 7, wherein:
said transfer drive assembly includes a sprocket bearing retainer cup disposed between said pair of transfer drive sprockets and said sprocket bearing.

9. A two wheel drive bicycle according to claim 8, wherein:
said bushing is two nylon bushings and said sprocket bearing is two sprocket bearings.

10. A two wheel drive bicycle, comprising:
a bicycle frame;
a front wheel coupled to said bicycle frame;
an A-frame pivotally coupled to said bicycle frame; and
a pair of rear drive wheels rotatably coupled to said A-frame, said drive wheels lying in substantially the same plane with said drive wheels being spaced apart fore and aft.

11. A two wheel drive bicycle according to claim 10, wherein:
said A-frame includes a cross member which limits rearward pivotal movement of said bicycle frame relative to said A-frame.

12. A two wheel drive bicycle according to claim 11, further comprising:
a transfer drive assembly coupled to said A-frame, wherein
at least one of said drive wheels has a drive sprocket, said drive sprocket being coupled to said transfer drive assembly by a first chain.

13. A two wheel drive bicycle according to claim 12, wherein:
said transfer drive assembly includes an outer pivot tube fixedly coupled to said bicycle frame and an inner cross tube rotatably coupled to said A-frame.

14. A two wheel drive bicycle according to claim 13, wherein:
said transfer drive assembly includes a pair of transfer drive sprockets non-rotatably coupled to each other and rotatably coupled to said inner cross tube,
one of said transfer drive sprockets being coupled to said first chain.

15. A two wheel drive bicycle according to claim 14, wherein:
said transfer drive assembly includes a bushing disposed between said outer pivot tube and said inner cross tube.

16. A two wheel drive bicycle according to claim 15, wherein:
said transfer drive assembly includes a sprocket bearing disposed between said pair of transfer drive sprockets and said inner cross tube.

17. A two wheel drive bicycle according to claim 16, wherein:
said transfer drive assembly includes a sprocket bearing retainer cup disposed between said pair of transfer drive sprockets and said sprocket bearing.

18. A two wheel drive bicycle according to claim 17, wherein:
said bushing is two bushings and said sprocket bearing is two sprocket bearings.

19. A two wheel drive bicycle according to claim 1, wherein:
said rear wheel frame includes a cross-member which limits rearward pivotal movement of said bicycle frame relative to said rear wheel frame.
